(19) United States
(12) Patent Application Publication
(10) Pub. No.: US 2008/0083718 A1
(43) Pub. Date: Apr. 10, 2008

(54) PTC airflow heater with airflow guider

(76) Inventor: Tianyu Gao, Shenzhen (CN)

Correspondence Address: Raymond Y. Chan;Suite 128, 108 N. Ynez Avenue, Monterey Park, CA, 91754, US

(21) Appl. No.: 11/518,577

(22) Filed: Sep. 8, 2006

(30) Foreign Application Priority Data
Aug. 25, 2006 (CN) 200610062275.3

(51) Int. Cl. B60L 1/02

(52) U.S. Cl. 219/202

(57) ABSTRACT

An airflow heater includes a housing, an air source to generate an airflow and a heat coverage enhancement supported in front of the air source. The heat coverage enhancement includes at least a PTC heat generating arrangement for generating heat, a heat dissipating arrangement for transmitting the heat therefrom, and an airflow guider frontwardly, outwardly, and inclinedly extended from the heat dissipating arrangement for deviating an exiting angle of the airflow, such that the airflow guider maximizes the exiting angle of the airflow with respect to the housing for enhancing a coverage of the airflow.

### BACKGROUND OF THE PRESENT INVENTION

1. Field of Invention

The present invention relates to a PTC airflow heater, and more particularly to a heat airflow heater which comprises an airflow guider to extend the coverage area of heated airflow so as to increase the efficiency of the airflow heater to provide heated air to the surrounding.

2. Description of Related Arts

Airflow heater, which comprises an electrical heating device as a heat source for heating up an airflow, is really common as a house appliance. Such conventional airflow heater usually comprises an electrical resistor and a heat plate to generate heat. Such conventional airflow heater does not have a heat controlling function. Therefore, the life span is low, and it is easy to malfunction and is not safe to use. Another type of conventional airflow heater uses a PTC (Positive Temperature Coefficient) heat generator and it is more efficient, reliable, and convenient. Therefore, the PTC type heater is commonly used in the electric system, electronic system and in the heating system of a vehicle. These kinds of PTC heat generators have a conducting function of using the positive temperature coefficient materials. Positive Temperature Coefficient (PTC) refers to materials that experience a decrease in electrical resistance before the temperature change (Tc) of PTC. Then, the PTC material experiences an increase in electrical resistance when the temperature is raised above the temperature change of the PTC. Materials which have useful engineering applications usually show a relatively rapid increase with temperature, i.e. a higher coefficient. The higher the coefficient, the greater an increase in electrical resistance for a given temperature increase. Using this characteristic of the PTC, many applications of heat sensitivity PTC ceramics can be manufactured.

Conventional airflow heater uses PTC heat generator 1 which comprises metal heat dissipating unit 2 installed at the heat generator. Referring to FIG. 1 of the drawings of a prior art, a PTC heat generator 1 comprises a heat dissipater 2 on both sides of the PTC heat generator 1. The PTC heat generator produces heat and is radiated to the surrounding through the dissipating unit. The conventional airflow heater further comprises a fan generating an airflow through the heat air area and thus blowing the heated air to an outlet of the airflow heater for various purposes. Referring to FIG. 1 of the drawings, a heated air coverage area A from the outlet can only be as large as the heat generator 1 and heat dissipater 2. In other words, the coverage area A is limited by the heat generator 1 and the heat dissipater 2. This design is very inefficient since the coverage area is very small. A rotational device is used to drive the housing of the heater to turn so as to expand the coverage area at the outlet of such a conventional design. In order to solve above problem, other design has been suggested. Referring to FIG. 2 of the drawings of another prior art, the PTC heat generator 1 and the heat dissipater 2 can be separated as two different units with a predetermined angle between them to extend the coverage area A. An air divider 4 is installed between the two separated units at a position behind the heat dissipater 2 to divide the airflow into two portions towards the two separated units respectively. This design complicates the overall mechanical structure of the device. It also increases the overall size of the device and its manufacture cost.

### SUMMARY OF THE PRESENT INVENTION

A main object of the present invention is to provide an airflow heater which comprises an integrated airflow guider to guide an airflow out of the PTC heat generating arrangement so as to achieve a larger area of airflow coverage. In addition, the PTC heat generating arrangement has a simple structure that allows to be easily assembled while being cost effective. In other words, the airflow heater has an integrated heat dissipating arrangement which is capable to dissipate heat to the surrounding and guide the airflow to a desired location.

Accordingly, in order to accomplish the above objects, the present invention provides a an airflow heater comprising a housing and an air source which is adapted for electrically connecting to a power source to generate an airflow, supported in said housing.

The airflow heater further comprises a heat coverage enhancement supported in said housing at a position in front of said air source. The heat coverage enhancement comprises at least a PTC heat generating arrangement for generating heat and at least a heat dissipating arrangement sidewardly extended from the PTC heat generating arrangement. The heat coverage enhancement further comprises an airflow guider frontwardly, outwardly, and inclinedly extended from the heat dissipating arrangement for outwardly and sidewardly deviating the airflow.

Accordingly, the airflow guider and the heat dissipating arrangement can form in one single module with an integrated structure. Alternatively, the airflow and the heat dissipating arrangement can be two individual components that airflow guider is detachably attached to a front side of the heat dissipating arrangement.

Each of the heat dissipating units comprises two retaining sidewalls and a plurality of heat dissipating elements conductively extended between the two retaining sidewalls for thermally conducting the heat from said PTC heat generating arrangement, wherein a heat dissipating channel is defined between every two of the heat dissipating elements, such that when the airflow passes through the heat dissipating channels, the airflow is heated up at a predetermined temperature before exiting out of the housing.

The airflow guider is frontwardly, outwardly, and inclinedly extended from at least one of the retaining sidewalls for deviating an exiting angle of the airflow towards an exit of the housing, such that the airflow guider maximizes the exiting angle of the airflow with respect to the housing for enhancing a coverage of the airflow.

Accordingly, the airflow guider is extended inclinedly at an acute angle with respect to the heat dissipating arrangement.

The airflow guider has a rectangular, V-shaped, or U-shaped cross section to guide the airflow out of the PTC heat generating arrangement.

The heat dissipating channel is made of a plurality of thin metallic layers having a triangular cross section and allowing the airflow to pass through.

The PTC heat generating arrangement is an elongated heating element adhesively sandwiched between two of the heat dissipating units to conductively transmit the heat from said elongated heating element.

Two or more heat dissipating arrangements can be formed an integrated unit with a plurality of retaining sidewalls, wherein each set of heat dissipating arrangements has two retaining sidewalls for the PTC heat generating arrangement mounting therebetween.

The airflow heater of the present invention enhances the airflow coverage via the airflow guider. Thus, the present invention does not involve complicated mechanical structures, so as to minimize the manufacturing cost and other related expenses of the airflow heater.

### BRIEF DESCRIPTION OF THE DRAWINGS

FIG. 1 is a side view of a conventional airflow heater with PTC heat generator.

FIG. 2 is a side view of another conventional airflow heater with PTC heat generator which uses air divider to separate the airflow.

FIG. 3A is a perspective view of a heat coverage enhancement of an airflow heater according to a preferred embodiment of the present invention, illustrating a configuration of the single PTC heat generator arrangement and the heat dissipating arrangement with the single airflow guider installed.

FIG. 3B is a sectional side view of a heat coverage enhancement according to the preferred embodiment of the present invention.

FIG. 3C illustrates an alternative mode of the heat coverage enhancement according to the preferred embodiment of the present invention.

FIG. 3D is a sectional side view of the alternative heat coverage enhancement according to the preferred embodiment of the present invention.

FIG. 3E illustrates a second alternative mode of the heat coverage enhancement according to the preferred embodiment of the present invention.

FIG. 3F illustrates a third alternative mode of the heat coverage enhancement according to the preferred embodiment of the present invention, showing the V-shaped airflow guider.

FIG. 4A is a perspective view of a heat coverage enhancement of an airflow heater according to a second preferred embodiment of the present invention, illustrating a configuration of the multiple PTC heat generator arrangement and the heat dissipating arrangement with the single airflow guider installed.

FIG. 4B illustrates an alternative mode of the heat coverage enhancement according to the second preferred embodiment of the present invention, showing two spaced apart airflow guiders.

FIG. 4C illustrates a second alternative mode of the heat coverage enhancement according to the second preferred embodiment of the present invention, showing the V-shaped airflow guider.

FIG. 4D illustrates an alternative mode of the heat coverage enhancement according to the second preferred embodiment of the present invention, showing two spaced apart V-shaped airflow guiders.

FIG. 5A is a perspective view of the airflow heater according to a third preferred embodiment of the present invention.

FIG. 5B illustrates an alternative mode of the airflow guider according to the above third preferred embodiment of the present invention.

FIG. 5C illustrates another alternative mode of the airflow guider according to the above third preferred embodiment of the present invention.

FIG. 6 is a side view of the airflow heater illustrating an extension of the coverage of airflow being heated up when the airflow is exiting according to the preferred embodiments of the present invention.

### DETAILED DESCRIPTION OF THE PREFERRED EMBODIMENT

The following embodiments give a more detail description of the present invention.

The present invention provides an airflow heater which blows out heated air. The airflow heater comprises a housing, an air source to generate an airflow, a heat coverage enhancement which is positioned in front of the air source to generate and dissipate heat to the surroundings. The air source, which is supported in the housing, comprises an air propeller electrically connecting to a power source so as to generate the airflow. The airflow passed through the heat coverage enhancement will be heated up. The heat coverage enhancement then guides the heated airflow to a desired location of an exiting side of the housing. The heat coverage enhancement comprises a PTC heat generating arrangement 10, a heat dissipating arrangement 20 extended from two sides of the PTC heat generating arrangement 10, and an airflow deviating unit to form a single module of PCT assembly. Accordingly, the airflow deviating unit can be integrated with the heat dissipating arrangement 20 to form an integrated unit or the airflow deviating unit can be detachably attached to the heat dissipating arrangement 20

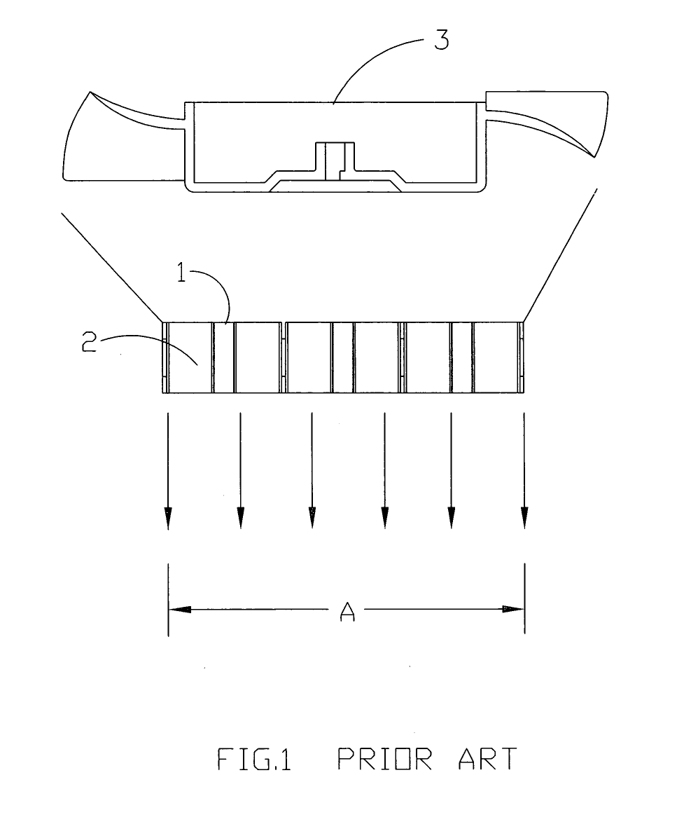

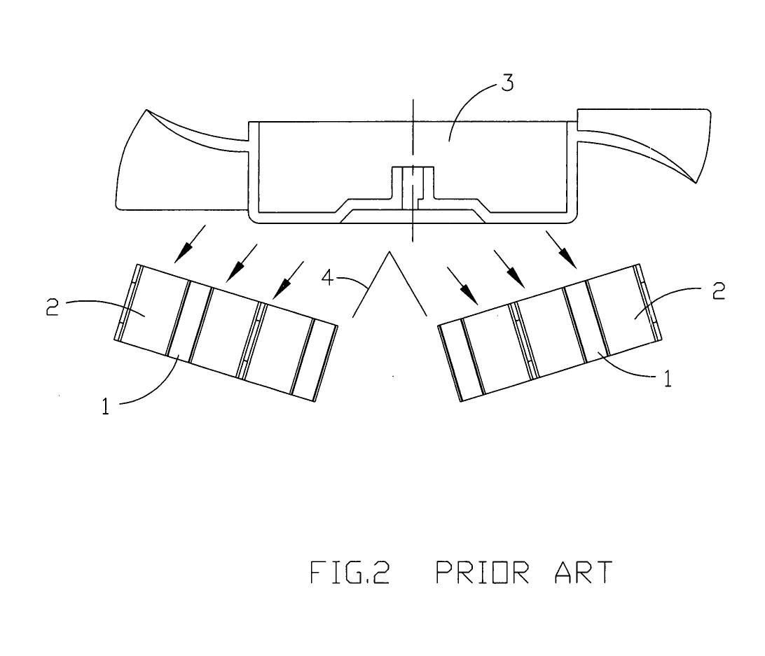

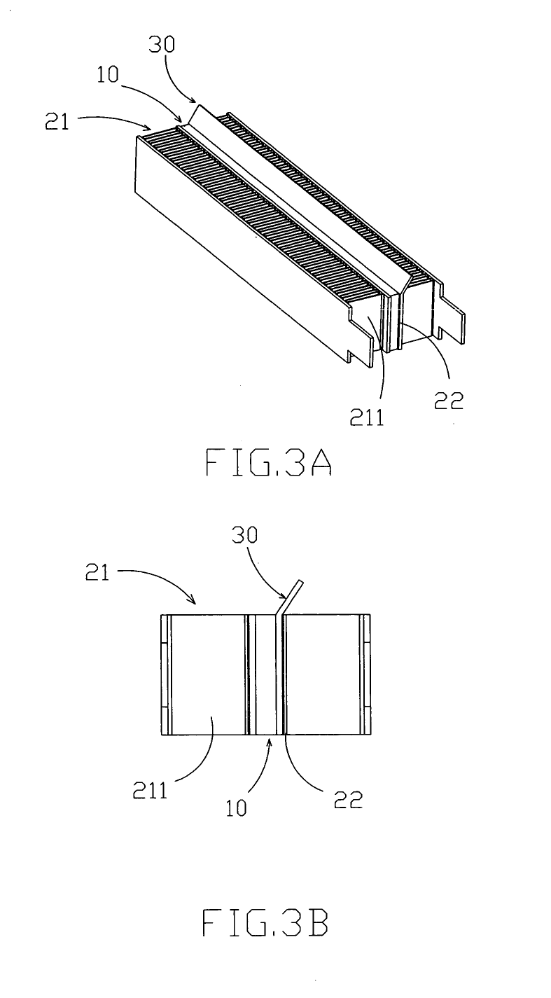

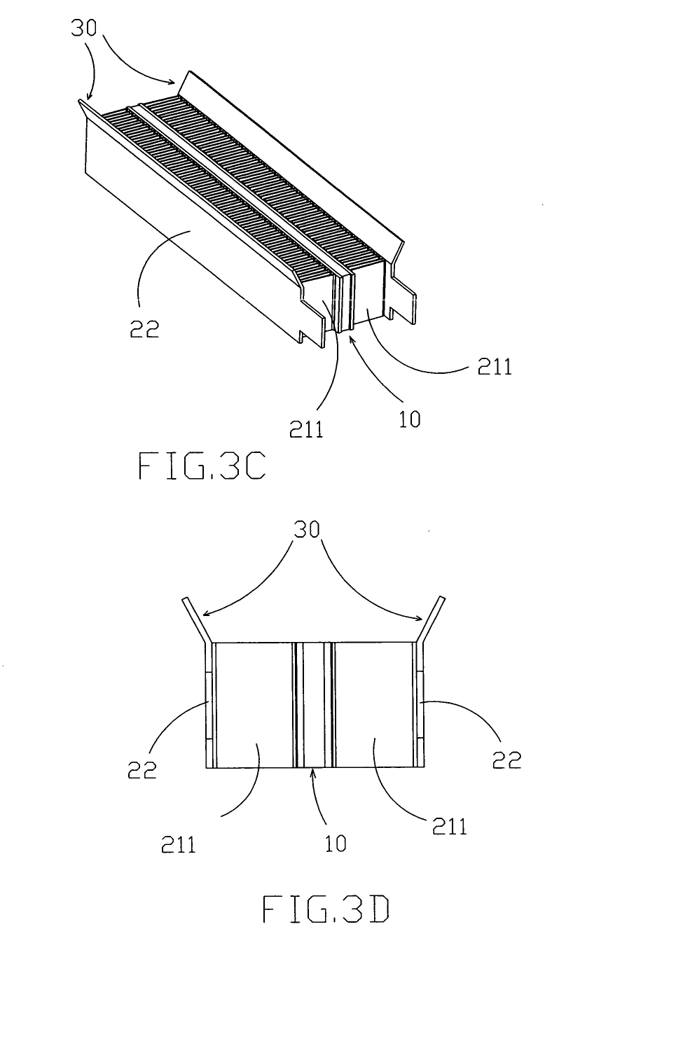

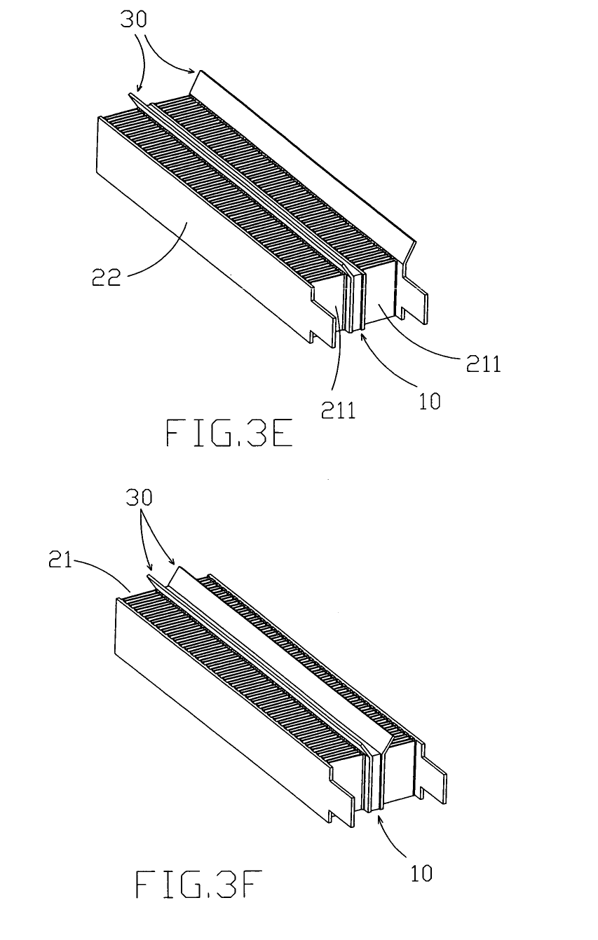

As shown in FIG. 3, the heat dissipating arrangement 20 comprises two heat dissipating units 21 as an individual set, wherein each of the dissipating units 21 comprises a plurality of heat dissipating elements 211 and two retaining sidewalls 22 attached thereto at a position that the heat dissipating elements 211 are spacedly mounted between the two retaining sidewalls 22. According to the preferred embodiment, the heat dissipating elements 211 are formed by an elongated metal panel made of aluminum alloy bent in a zigzag manner, wherein two side edges of each of the heat dissipating elements 211 are securely attached to the retaining sidewalls 22 respectively by welding. It is worth to mention that the heat dissipating elements 211 is made of material giving high heat transfer coefficient to transfer heat conductively from the surrounding efficiently. A heat dissipating channel is formed between every two of the heat dissipating elements 211, wherein the heat dissipating channel has a triangular cross section or trapezoid cross section for allowing the airflow passing through from the air source to the airflow deviating unit. In other words, the airflow is heated up when the airflow passes through the heat dissipating channels. The PTC heat generating arrangement 10 is mounted between the two heat dissipating units 21. The PTC heat generating arrangement 10 comprises an elongated heating element sandwiched between the two heat dissipating units 21. Accordingly, when the elongated heating element is shorter than the heat dissipating unit 21, two or more elongated heating elements can be located end-to-end to extend the overall length thereof in order to fit between the two heat dissipating units 21. Accordingly, the two corresponding retaining sidewalls 22 of the two heat dissipating units 21 are mounted to two sides of the elongated heating element of the PTC heat generating arrangement 10 respectively by applying an adhesive thereto while the adhesive is made of material that the heat can be conductively transmitted from the PTC heat generating arrangement 10 to the two heat dissipating units 21. The end terminal of the PTC heat generating arrangement 10 is electrically connected to the power source. According to the preferred embodiment, the airflow deviating unit comprises an airflow guider 30 is extended from a front side of at least one of the heat dissipating units 21, wherein the airflow deviating unit can be a flat panel or have a V-shaped cross section, a U-shaped cross section or other curved shaped panel. In particularly, the airflow guider 30 is frontwardly, outwardly, and inclinedly extended from one of the retaining sidewalls 22 of the heat dissipating unit 21. The airflow guider 30 is made of aluminum. In other words, the airflow guider 30 is extended at the exiting side of the retaining sidewall 22 of the heat dissipating arrangement 20. A shown in FIG. 3B, the airflow guider 30 extends out at the exiting side of the heat dissipating arrangement 20 forming an acute angle α with respect to the heat dissipating arrangement 20. The angle α as the exiting angle can be changed to adapt to different applications as desired. Therefore, when the airflow hits the airflow guider 30 after the airflow is heated up through the heat dissipating channels, the airflow is spread out at the exiting side of the heat dissipating arrangement 20. In other words, when the air source 40 generates the airflow towards the PTC heat generating arrangement 10 and a heat dissipating arrangement 20 of the heat coverage enhancement, the heated airflow is deviated via the airflow guider 30 to maximize a coverage area B as shown in FIG. 6 in comparison with the coverage area A in FIG. 1 of prior art. According to the preferred embodiment, the integrated airflow guider 30 locates at different positions resulting in different coverage area extension. As shown in FIGS. 3A and 3B, the airflow guider 30 is sandwiched between the PTC heat generating arrangement 10 and the corresponding heat dissipating unit 21, wherein the airflow guider 30 is a flat panel inclinedly, frontwardly, and outwardly extended from the inner retaining sidewall 22 of one of the heat dissipating units 21. Therefore, only a portion of the airflow is deviated via the airflow guider 30 when the airflow passes through the corresponding heat dissipating unit 21 to extend the coverage area at one side. There is unchanged for the rest portion of the airflow passing through another heat dissipating unit 21. In other words, this configuration allows the airflow to be guided to one side. As shown in FIGS. 3C and 3D, two airflow guiders 30, each having a flat panel structure, extends inclinedly, frontwardly, and outwardly from two outer retaining sidewalls 22 of the two heat dissipating units 21 respectively. Accordingly, the two airflow guiders 30 are inclinedly extended at different directions. In addition, the airflow guiders 30 are integrally extended from the retaining sidewalls 22 respectively. This configuration allows the control of the exiting angle of the outgoing airflow after the airflow is heated up. Referring to FIG. 3E of the drawings, two airflow guiders 30, each having a flat panel structure, are used, wherein one of the airflow guiders 30 is inclinedly, frontwardly, and outwardly extended from the inner retaining sidewall 22 of one of the heat dissipating units 21 and another airflow guider 30 is inclinedly, frontwardly, and outwardly extended from the outer retaining sidewall 22 of another heat dissipating unit 21. Accordingly, the two airflow guiders 30 are inclinedly extended at different directions to guide the airflow. As shown in FIG. 3F, two airflow guiders 30, each having a flat panel, are inclinedly, frontwardly, and outwardly extended from two inner retaining sidewalls 22 of the two heat dissipating units 21 respectively such that the two airflow guiders 30 forms a V-shaped cross section. In other words, the V-shaped airflow guider 30, which is a combined of two flat panel shaped airflow guiders 30, is installed on the retaining sidewalls 22 so as to separate the airflow when exiting from the heat dissipating arrangement 20.

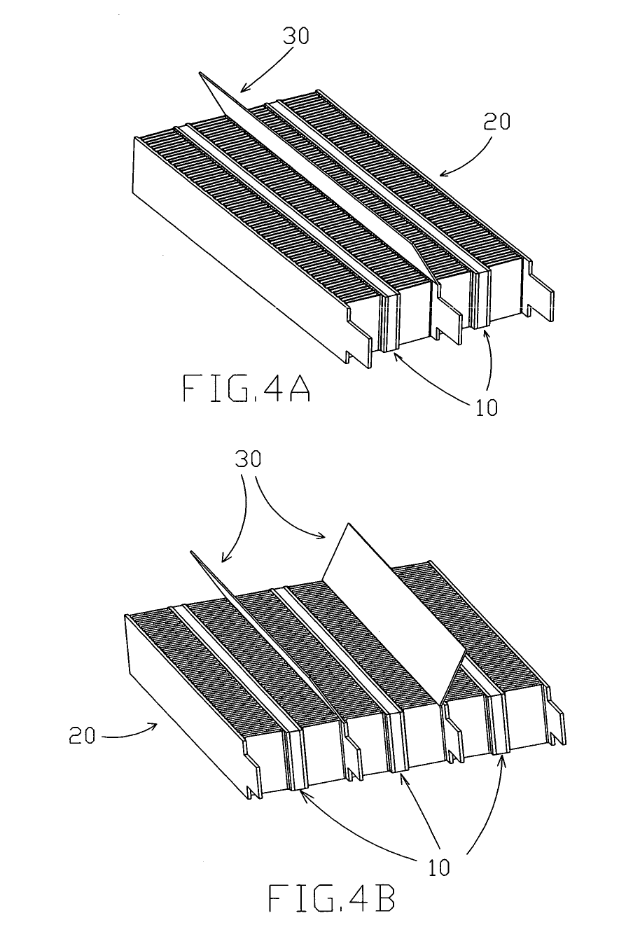

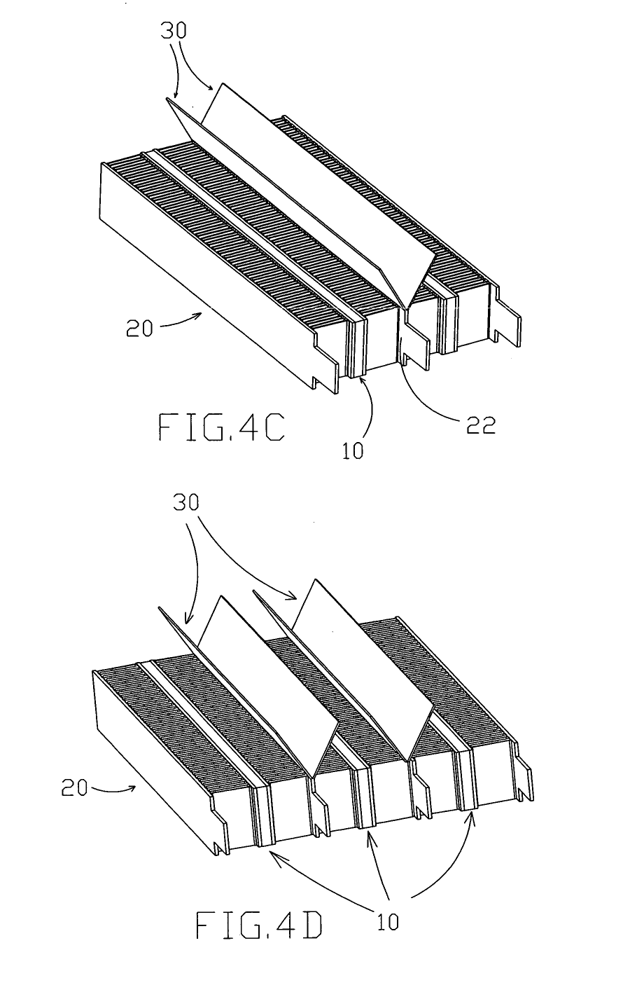

As shown in FIG. 4, an airflow arrangement of a second embodiment illustrates an alternative mode of the first embodiment of the present invention, wherein the second embodiment has the same structural components of the first embodiment, including the PTC heat generating arrangements 10, the heat dissipating arrangements 20, and the airflow guider 30. The first embodiment illustrates a single module of heat coverage enhancement while the first embodiment illustrates a multiple module of heat coverage enhancement. According to the second embodiment, the heat coverage enhancement comprises a plurality of PTC heat generating arrangements 10, and a plurality of heat dissipating arrangements 20, wherein the heat generating arrangements 10 and the heat dissipating arrangements 20 are mounted in an alternated manner. As shown in FIG. 4A, there are two sets of heat dissipating units 21, i.e. four heat dissipating units 21, wherein the airflow guider 30 is extended at the retaining sidewall 22 at the position between the two sets of heat dissipating units 21. As shown in FIG. 4B, three sets of heat dissipating units 21, i.e. six heat dissipating units 21, wherein two airflow guiders 30 are extended at the retaining sidewalls 22 at a position between the first and second heat dissipating units 21 and between the second and third heat dissipating units 21 respectively. As shown in FIG. 4C, there are two sets of heat dissipating units 21 wherein two airflow guiders 30 are extended from the middle retaining sidewall 22 of the of heat dissipating units 21 to form a V-shaped cross sectional structure. As shown in FIG. 4D, there are three sets of heat dissipating units 21 wherein four airflow guiders 30 are extended at the retaining sidewalls 22 at a position between the first and second heat dissipating units 21 and between the second and third heat dissipating units 21 to form two V-shaped airflow guiders respectively. All the configurations described above helps extend the coverage area B of airflow and guide the airflow to a predetermined location as shown in FIG. 6 of the drawings.

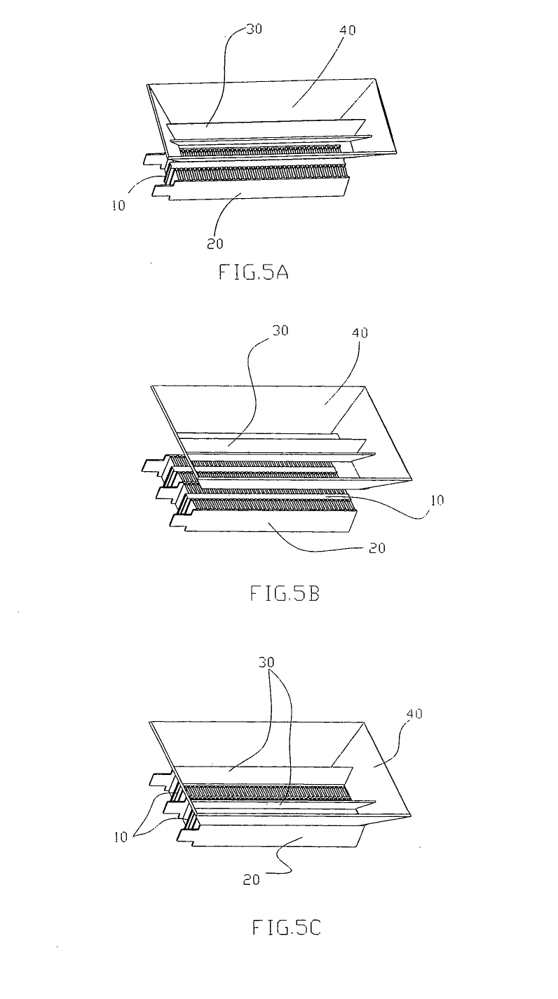

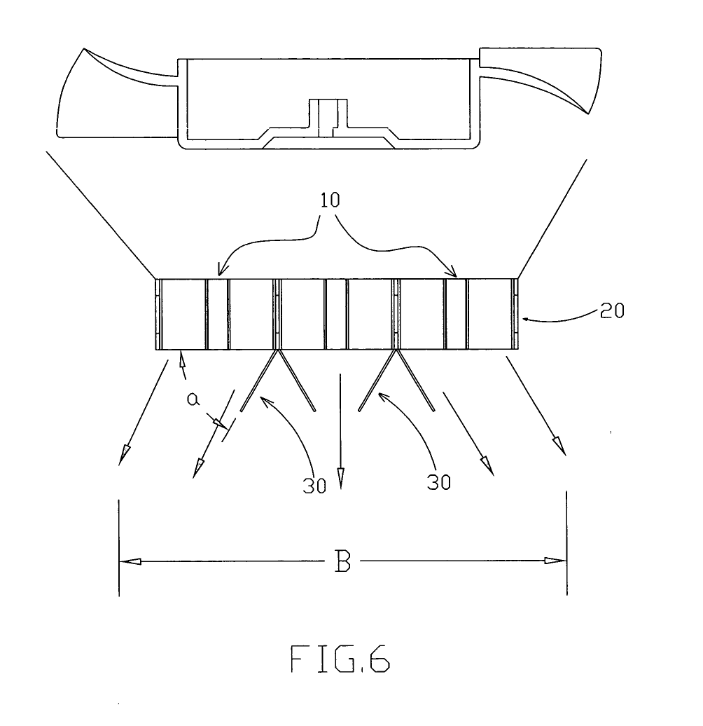

As shown in FIG. 5A, an airflow heater of a third embodiment illustrates another alternative mode of the first and second embodiments of the present invention, wherein the airflow heater of the third embodiment has the same structure of the first and second embodiments expect the airflow deviating unit is detachably attaching to the heat dissipating arrangement 20. As shown in FIGS. 5A to 5C, the heat coverage enhancement further comprises an airflow guiding frame 40 mounted in front of the heat dissipating arrangement 20 at the exiting side thereof, wherein the airflow guiders 30 are spacedly mounted within the airflow guiding frame 40. Accordingly, the airflow guiders 30 can be attached to the airflow guiding frame 40 by ultrasonic welding or the airflow guiders 30 can be integrally attached to the airflow guiding frame 40 to form a one-piece structure. The airflow guiding frame 40 comprises four surrounding walls outwardly and inclinedly extending in such a manner that a size of the airflow guiding frame 40 is gradually increasing from an inner opening to an outer opening. In order to withstand the heat from the PTC heat generating arrangements 10, the airflow guiding frame 40 should be made of heat insulating material such as engineering plastic or thermoplastic that exhibit superior thermal properties. Accordingly, the airflow guiding frame 40 is mounted at the exiting side of the heat dissipating arrangement 20 by screws or other fastening elements. As shown in FIG. 5A, the airflow guiding frame 40 is mounted to the heat dissipating arrangement 20 of the first embodiment as a single module, wherein the airflow guiders 3 are mounted within the airflow guiding frame 40 to form a V-shaped structure, such that when the airflow guiding frame 40 is mounted to the exiting side of the heat dissipating arrangement 20, the airflow guiders 30 are aligned thereto. As shown in FIG. 5B, the airflow guiders 3 are mounted within the airflow guiding frame 40 to form a V-shaped structure, wherein the airflow guiding frame 40 is mounted to the heat dissipating arrangement 20 of the second embodiment as a multiple module. As shown in FIG. 5C, the two airflow guiders 30 are spaced mounted within the airflow guiding frame 40 for fitting to the heat dissipating arrangement 20 of the second embodiment as a multiple module.

One skilled in the art will understand that the embodiment of the present invention as shown in the drawings and described above is exemplary only and not intended to be limiting.

It will thus be seen that the objects of the present invention have been fully and effectively accomplished. The embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. An airflow heater, comprising:
a housing;
an air source which is adapted for electrically connecting to a power source to generate an airflow, supported in said housing; and
a heat coverage enhancement, which is supported in said housing at a position in front of said air source, comprising:
at least a PTC heat generating arrangement for generating heat;
a heat dissipating arrangement comprising at least two heat dissipating units extended from two sides of said PTC heat generating arrangement for transmitting said heat therefrom, wherein each of said heat dissipating units comprises two retaining sidewalls and a plurality of heat dissipating elements conductively extended between said two retaining sidewalls for thermally conducting said heat from said PTC heat generating arrangement, wherein a heat dissipating channel is defined between every two of said heat dissipating elements, such that when said airflow passes through said heat dissipating channels, said airflow is heated up at a predetermined temperature before exiting out of said housing; and
an airflow deviating unit frontwardly, outwardly, and inclinedly extended from at least one of said retaining sidewalls for deviating an exiting angle of said airflow towards an exit of said housing, such that said airflow deviating unit maximizes said exiting angle of said airflow with respect to said housing for enhancing a coverage of said airflow.

2. The airflow heater, as recited in claim 1, wherein said airflow deviating unit comprises at least an airflow guider extending frontwardly, outwardly, and inclinedly out from at least one of said retaining sidewalls forming an acute angle with respect to said heat dissipating arrangement.

3. The airflow heater, as recited in claim 1, wherein said airflow deviating unit comprises two airflow guiders extending inclinedly, frontwardly, and outwardly from said two retaining sidewalls of said two heat dissipating units at two outer positions respectively, wherein said two airflow guiders are inclinedly and outwardly extended at different directions, wherein each of said airflow guiders is inclinedly extended at an acute angle with respect to said heat dissipating arrangement.

4. The airflow heater, as recited in claim 1, wherein said airflow deviating unit comprises two airflow guiders extending from said two retaining sidewalls of said two heat dissipating units at two inner positions respectively, wherein said two airflow guiders are inclinedly and outwardly extended at different directions to form a V-shape cross section, wherein each of said airflow guiders is inclinedly extended at an acute angle with respect to said heat dissipating arrangement.

5. The airflow heater, as recited in claim 1, wherein said airflow deviating unit comprises two airflow guiders, wherein one of said airflow guiders extends inclinedly, frontwardly, and outwardly from said retaining sidewall of one of said heat dissipating units at an outer position while another said airflow guider extends inclinedly, frontwardly, and outwardly from said retaining sidewall of another said heat dissipating unit at an inner position, wherein said two airflow guiders are inclinedly and outwardly extended at different directions, wherein each of said airflow guiders is inclinedly extended at an acute angle with respect to said heat dissipating arrangement.

6. The airflow heater, as recited in claim 2, wherein said airflow guider is integrally extended from said corresponding retaining sidewall of said heat dissipating unit.

7. The airflow heater, as recited in claim 3, wherein said airflow guider is integrally extended from said corresponding retaining sidewall of said heat dissipating unit.

8. The airflow heater, as recited in claim 4, wherein said airflow guider is integrally extended from said corresponding retaining sidewall of said heat dissipating unit.

9. The airflow heater, as recited in claim 5, wherein said airflow guider is integrally extended from said corresponding retaining sidewall of said heat dissipating unit.

10. The airflow heater, as recited in claim 2, wherein an elongated metal panel made of aluminum alloy bent in a zigzag manner to form said heat dissipating elements between said two corresponding retaining sidewalls of each of said heat dissipating units, wherein each of said heat dissipating channels has a trapezoid cross section for allowing said airflow passing through.

11. The airflow heater, as recited in claim 3, wherein an elongated metal panel bent in a zigzag manner to form said heat dissipating elements between said two corresponding retaining sidewalls of each of said heat dissipating units, wherein each of said heat dissipating channels has a trapezoid cross section for allowing said airflow passing through.

12. The airflow heater, as recited in claim 4, wherein an elongated metal panel bent in a zigzag manner to form said heat dissipating elements between said two corresponding retaining sidewalls of each of said heat dissipating units, wherein each of said heat dissipating channels has a trapezoid cross section for allowing said airflow passing through.

13. The airflow heater, as recited in claim 5, wherein an elongated metal panel bent in a zigzag manner to form said heat dissipating elements between said two corresponding retaining sidewalls of each of said heat dissipating units, wherein each of said heat dissipating channels has a trapezoid cross section for allowing said airflow passing through.

14. The airflow heater, as recited in claim 11, wherein said heat coverage enhancement further comprises an airflow guiding frame detachably mounted in front of said heat dissipating arrangement at said exiting side thereof, wherein said airflow guiders are mounted within said airflow guiding frame, to retain said airflow guiders in position, wherein said airflow guiding frame comprises four surrounding walls outwardly and inclinedly extending in such a manner that a size of said airflow guiding frame is gradually increasing from an inner opening to an outer opening.

15. The airflow heater, as recited in claim 12, wherein said heat coverage enhancement further comprises an airflow guiding frame detachably mounted in front of said heat dissipating arrangement at said exiting side thereof, wherein said airflow guiders are mounted within said airflow guiding frame, to retain said airflow guiders in position, wherein said airflow guiding frame comprises four surrounding walls outwardly and inclinedly extending in such a manner that a size of said airflow guiding frame is gradually increasing from an inner opening to an outer opening.

16. The airflow heater, as recited in claim 13, wherein said heat coverage enhancement further comprises an airflow guiding frame detachably mounted in front of said heat dissipating arrangement at said exiting side thereof, wherein said airflow guiders are mounted within said airflow guiding frame, to retain said airflow guiders in position, wherein said airflow guiding frame comprises four surrounding walls outwardly and inclinedly extending in such a manner that a size of said airflow guiding frame is gradually increasing from an inner opening to an outer opening.

17. The airflow heater, as recited in claim 2, wherein said PTC heat generating arrangement comprises an elongated heating element securely mounted between said two heat dissipating units at a position that said elongated heating element is sandwiched between said two corresponding retaining sidewalls of said two heat dissipating units respectively so as to conductively transmit said heat from said elongated heating element to said heat dissipating units.

18. The airflow heater, as recited in claim 3, wherein said PTC heat generating arrangement comprises an elongated heating element securely mounted between said two heat dissipating units at a position that said elongated heating element is sandwiched between said two corresponding retaining sidewalls of said two heat dissipating units respectively so as to conductively transmit said heat from said elongated heating element to said heat dissipating units.

19. The airflow heater, as recited in claim 4, wherein said PTC heat generating arrangement comprises an elongated heating element securely mounted between said two heat dissipating units at a position that said elongated heating element is sandwiched between said two corresponding retaining sidewalls of said two heat dissipating units respectively so as to conductively transmit said heat from said elongated heating element to said heat dissipating units.

20. The airflow heater, as recited in claim 5, wherein said PTC heat generating arrangement comprises an elongated heating element securely mounted between said two heat dissipating units at a position that said elongated heating element is sandwiched between said two corresponding retaining sidewalls of said two heat dissipating units respectively so as to conductively transmit said heat from said elongated heating element to said heat dissipating units.
